(19) United States
(12) Patent Application Publication
(10) Pub. No.: US 2012/0193591 A1
(43) Pub. Date: Aug. 2, 2012

(54) Telescopic Apparatus

(76) Inventor: Han-Ching Huang, (US)

(21) Appl. No.: 13/015,216

(22) Filed: Jan. 27, 2011

(51) Int. Cl. B66F 3/36

(52) U.S. Cl. 254/100

(57) ABSTRACT

A telescopic apparatus includes two tubes, a positioning unit and two contact units. The tubes are telescopically connected to each other. The positioning unit is operable for moving and positioning the tubes relative to each other. Each of the contact units includes a cap secured to a relative one of the tubes and a pad pivotally and elastically connected to the cap.

### BACKGROUND OF INVENTION

1. Field of Invention

The present invention relates to a telescopic apparatus and, more particularly, to a telescopic apparatus with two safe contact units.

2. Related Prior Art

Referring to FIG. 1, there is shown a conventional telescopic apparatus 10 including a first tube 11, a second tube 12 telescopically inserted in the first tube 11, a positioning unit 20 operable for moving and positioning the first tube 11 relative to the second tube 12, and two contact units 30 connected to a related one of the first tube 11 and the second tube 12. The first tube 11 includes a threaded section 14 formed thereon and two opposite slots 15 defined in the threaded section 14. A grip 13 is firmly provided on the first tube 11. The second tube 12 includes a groove 16 longitudinally defined therein and apertures 17 transversely defined therein so that the groove 16 is in communication with all of the apertures 17.

The positioning unit 20 includes a ring 21, a pin 22 and a nut 23. The ring 21 includes a rib 24 extending longitudinally on an internal face thereof. The nut 23 is engaged with the threaded section 14 of the first tube 11. The pin 22 is inserted through a selected one of the apertures 17, with two ends thereof located on the nut 23. The ring 21 is connected to an end of the first tube 11 near the threaded section 14, with the rib 24 movably located in the groove 17. As the nut 23 is spun and moved relative to the threaded section 14 of the first tube 11, the pin 22 and therefore the second tube 12 are moved relative to the first tube 11 by the nut 23.

Each of the contact units 30 includes a plug or cap 31 connected to the first tube 11 or the second tube 12, a screw 32 partially inserted in the plug or cap 31, a plate 33 formed with two lugs 35, and another screw 36 driven in the screw 32 through the lugs 35, and a pad 34 attached to the plate 33. The plate 33 is made of metal, and the pad 34 rubber. The total weight of the plate 33 and the pad 34 is considerable. The plate 33 and the pad 34 are pivotally connected to the screw 32. In maneuver of the telescopic apparatus 10, the plate 33 and the pad 34 are cast like the tip of a whip and could damage properties or hurt people.

The present invention is therefore intended to obviate or at least alleviate the problems encountered in prior art.

### SUMMARY OF INVENTION

It is the primary objective of the present invention to provide a safe telescopic apparatus.

To achieve the foregoing objective, the telescopic apparatus includes two tubes, a positioning unit and two contact units. The tubes are telescopically connected to each other. The positioning unit is operable for moving and positioning the tubes relative to each other. Each of the contact units includes a cap secured to a relative one of the tubes and a pad pivotally and elastically connected to the cap.

The pad may include a rubber block and a metal plate partially embedded in the rubber block.

The metal plate may include a dome and a brim extending from and around the dome thereon. The entire brim is embedded in the rubber block.

The cap may include an arched end plate for containing the dome.

The pad may include a screw inserted through the dome and the arched end plate and a nut engaged with the screw.

The pad may include a helical spring compressed between an enlarged head of the screw and the dome.

The rubber block may include a chamber for containing the helical spring.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of a conventional telescopic apparatus;

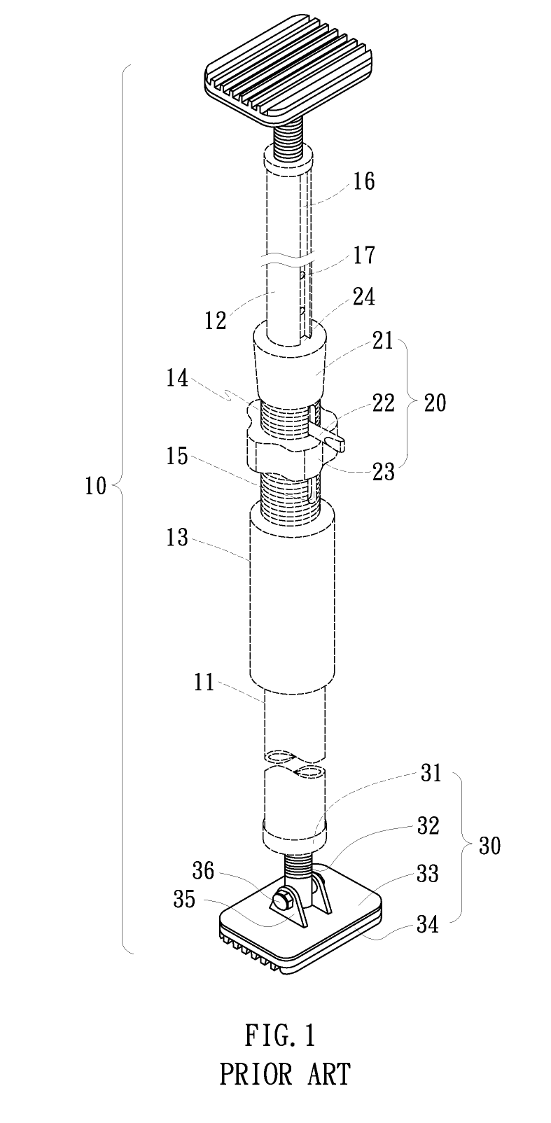

FIG. 2 is a perspective view of a telescopic apparatus according to the preferred embodiment of the present invention;

FIG. 3 is an exploded view of a contact unit of the telescopic apparatus shown in FIG. 2;

FIG. 4 is a cross-sectional view of the contact unit shown in FIG. 3; and

FIG. 5 is a cross-sectional view of the contact unit in another position than shown in FIG. 4.

### DETAILED DESCRIPTION OF PREFERRED EMBODIMENT

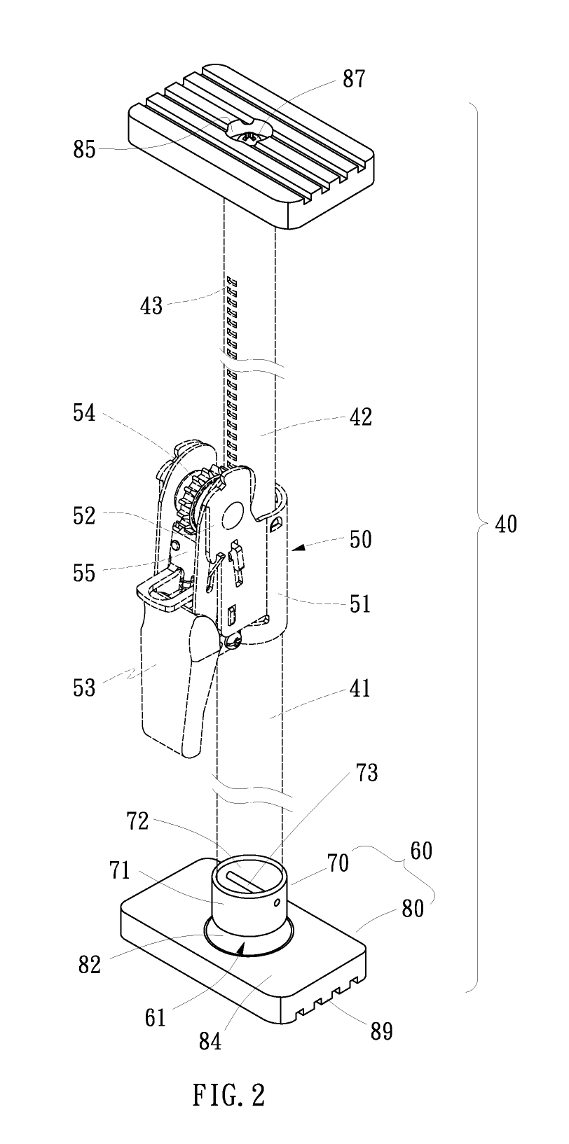

Referring to FIG. 2, a safe telescopic apparatus 40 includes a first tube 41, a second tube 42 telescopically inserted in the first tube 41, a positioning unit 50 operable for moving and positioning the first tube 41 relative to the second tube 42, a first contact unit 60 connected to the first tube 41, and a second contact unit 60 connected to the second tube 42 according to the preferred embodiment of the present invention. The second tube 42 includes recesses 43 defined therein.

The positioning unit 50 includes a frame 51 firmly connected to the first tube 41, two fins 52 extending from the frame 51, a handle 53 pivotally connected to the frame 51, a first spring-biased detent 55 movably provided on the handle 53, a toothed wheel 54 rotationally provided on the fins 52, and a second sprig-biased detent movably provided on the fins 52.

In use, the handle 53 is pivoted to and fro relative to the fins 52. When the handle 53 is pivoted relative to the fins 52 in an active direction, the toothed wheel 54 is spun since it is engaged with the first spring-biased detent 55 and allowed to rattle on the second spring-biased detent. The second tube 42 is extended from the first tube 41 for a distance since some of the recesses 43 receive some of the teeth of the toothed wheel 54.

When the handle 53 is pivoted relative to the fins 52 in an opposite idle direction, the first spring-biased detent 55 rattles on the toothed wheel 54 as the toothed wheel 54 is retained in position by the second spring-biased detent. The second tube 42 is retained in position relative to the first tube 41.

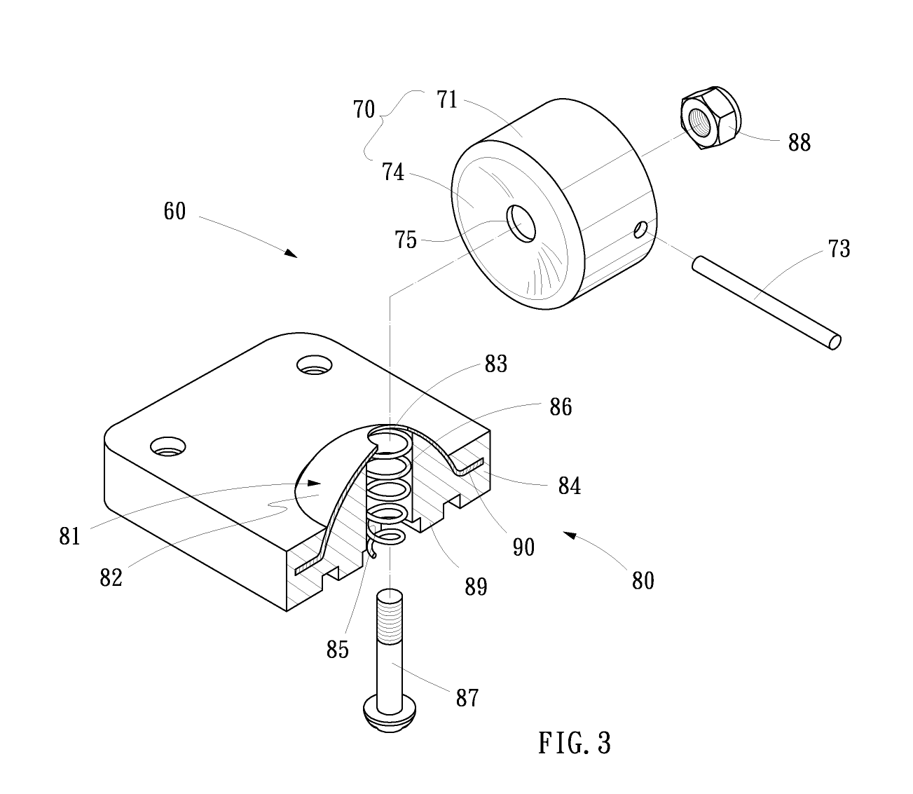

Referring to FIG. 3, each of the first and second contact units 60 includes a cap 70 and a pad 80 pivotally connected to the cap 70. The cap 70 includes a wall 71 extending from and around an arched end plate 74. An aperture 75 is centrally defined in the circular end plate 74.

The pad 80 includes a metal plate 81 and a rubber block 84. The metal plate 81 includes a dome 82 and a brim 90 extending from and around the dome 82. An aperture 83 is centrally defined in the dome 82. A portion of the dome 82 and the entire brim 90 are embedded in the rubber block 84. The rubber block 84 includes a chamber 85 defined therein and ribs 89 formed thereon.

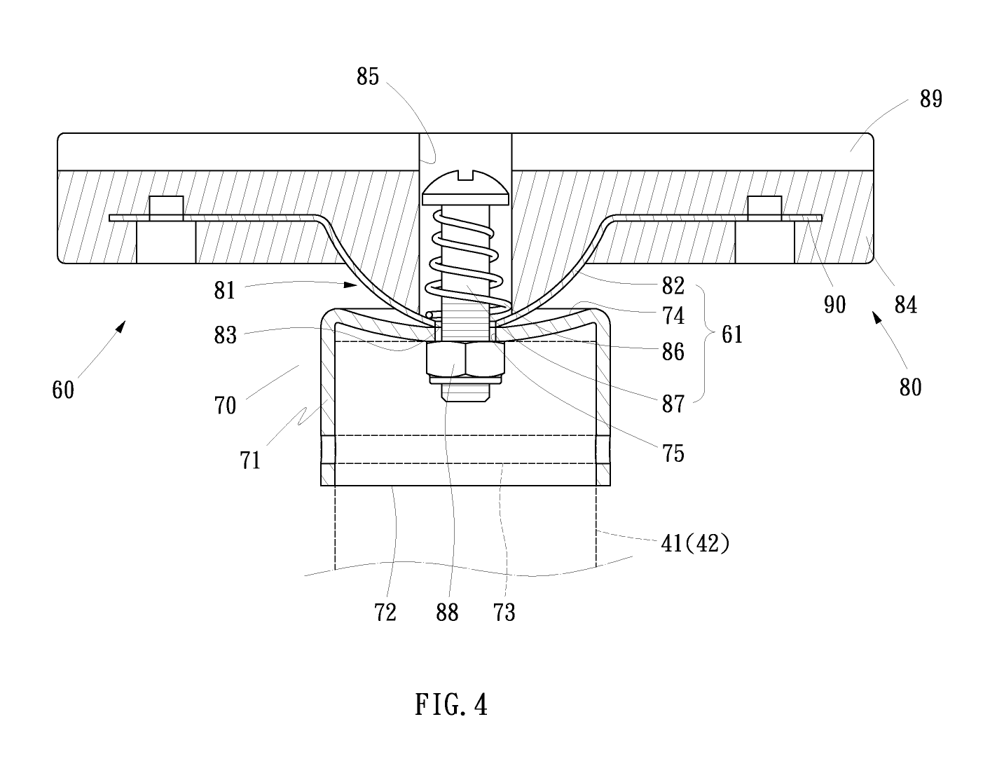

Referring to FIG. 4, in assembly, the dome 82 is located in the arched end plate 74. A helical spring 86 is located in the chamber 85. The diameter of the chamber 85 is smaller than that of the helical spring 86. A screw 87 is inserted through the helical spring 86, the aperture 83 and the aperture 75 before it is engaged with a nut 88. Thus, the helical spring 86 is compressed between the dome 82 and an enlarged head of the screw 87. Hence, the dome 82 is pushed against the arched end plate 74. The wall 71 of the cap 70 is located around an end of the first tube 41 or the second tube 42 before a pin 73 is driven in them. The pad 80 will not be cast like the tip of a whip when the telescopic apparatus 40 is maneuvered because there is friction between the dome 82 and the arched end plate 74.

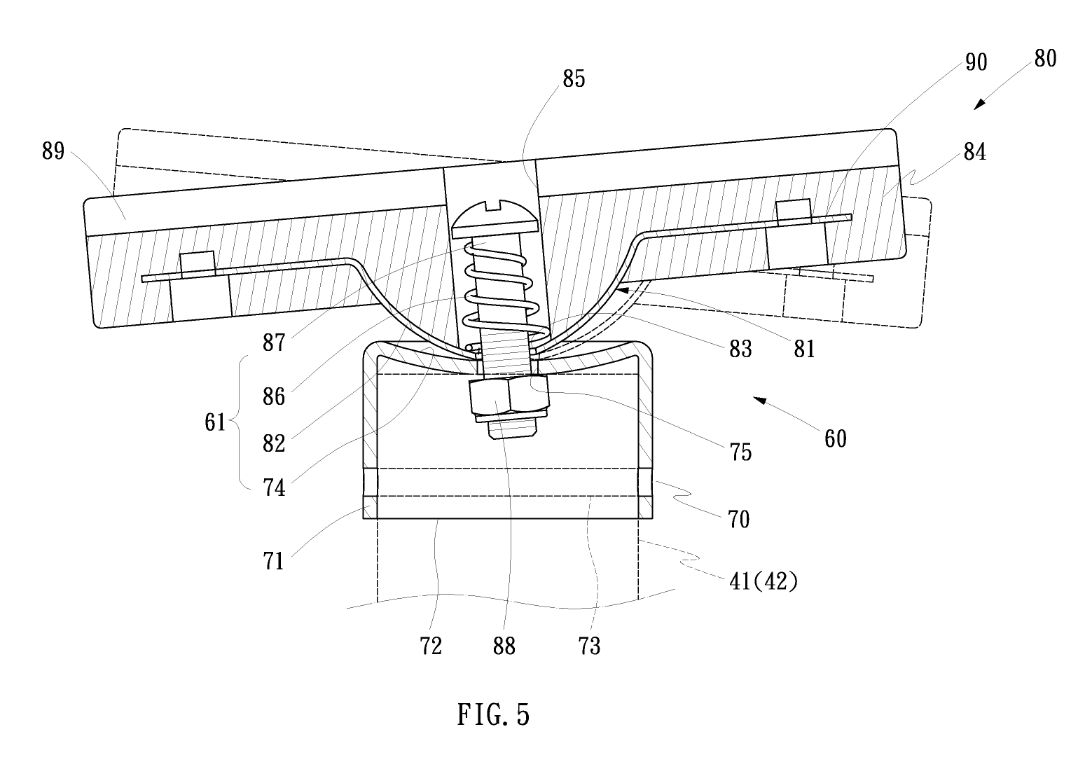

Referring to FIG. 5, the pad 80 can be pivoted relative to the cap 70 in a small range. Thus, the pad 80 can be in firm contact with a wall, floor or roof not extending perfectly parallel to an axis of the telescopic apparatus 40. The ribs 89 are used to enhance the contact. However, the helical spring 86 is further loaded when the pad 80 is pivoted relative to the cap 70. Therefore, the pad 80 will be returned to the position shown in FIG. 4 immediately after it is removed from the wall, floor or roof.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A telescopic apparatus including:
two tubes telescopically connected to each other;
a positioning unit operable for moving and positioning the tubes relative to each other; and
two contact units each including:
a cap secured to a relative one of the tubes; and
a pad pivotally and elastically connected to the cap.

2. The telescopic apparatus according to claim 1, wherein the pad includes a rubber block and a metal plate partially embedded in the rubber block.

3. The telescopic apparatus according to claim 2, wherein the metal plate includes a dome and a brim extending from and around the dome thereon, wherein the entire brim is embedded in the rubber block.

4. The telescopic apparatus according to claim 3, wherein the cap includes an arched end plate for containing the dome.

5. The telescopic apparatus according to claim 4, wherein the pad includes a screw inserted through the dome and the arched end plate and a nut engaged with the screw.

6. The telescopic apparatus according to claim 5, wherein the pad includes a helical spring compressed between an enlarged head of the screw and the dome.

7. The telescopic apparatus according to claim 6, wherein the rubber block includes a chamber for containing the helical spring.
